(19) United States
(12) Patent Application Publication
(10) Pub. No.: US 2022/0106509 A1
(43) Pub. Date: Apr. 7, 2022

(54) ENVIRONMENTALLY-FRIENDLY DUST SUPPRESSANT POLYMER BLEND

(71) Applicant: Arizona Board of Regents on Behalf of the University of Arizon, Tucson, AZ (US)

(72) Inventors: Minkyu Kim, Tucson, AZ (US); Taehee Lee, Tucson, AZ (US)

(21) Appl. No.: 17/442,017

(22) PCT Filed: Mar. 20, 2020
(86) PCT No.: PCT/US20/24058

§ 371 Date: Sep. 22, 2021

Related U.S. Application Data
(60) Provisional application No. 62/822,182, filed on Mar. 22, 2019.

(51) Int. Cl. C09K 3/22

(52) U.S. Cl. CPC C09K 3/22

(57) ABSTRACT

Environmentally-friendly dust suppressant polymer compositions, the preparation thereof, and the use thereof for methods for dust suppression is disclosed herein.

### CROSS-REFERENCE TO RELATED APPLICATIONS

This application claims the benefit of U.S. Provisional Appl. 62/822,182, filed Mar. 22, 2019. The content of the foregoing application is relied upon and is incorporated by reference herein in its entirety.

### FIELD OF THE INVENTION

The field of the invention relates generally to relates to a dust control, and in particular to compositions, concentrates, and methods for dust control using biocompatible and environmentally friendly polymers and biopolymers.

### BACKGROUND

According to the World Health Organization (WHO), 3.1 million people died due to the air pollution in 2010. In 2013, WHO declares to designate particulate matter (PM), also known as particle pollution, as a Group 1 carcinogen because of their ability to penetrate lung epithelium and enter the bloodstream, causing various types of cancers as well as DNA mutations, heart attacks, and premature death. PM is typically classified as PM10 (less than 10 μm in a diameter; fine dust) and PM2.5 (less than 2.5 μm in a diameter; ultrafine dust) [1]. To suppress the dust, the general method is watering to dust sources. When water is sprayed on fugitive dust, dust particles are trapped by water molecules and dropped on the ground. The wetted dust can be agglomerated together assisted by the capillary force between the particle and water, and suppressed on the ground [2, 3]. However, the effectiveness of dust suppression is temporary because of quick water evaporation in ambient conditions, requiring frequent watering to continuously control dust that can be re-floated from the ground into the air. To improve the effectiveness of watering, additives as dust suppressants are employed to attract moisture (chloride salts), or to adhere dust particles on the surface (emulsified asphalt, resins, and polymeric solutions) [4, 5]. However, many of these additives have critical disadvantages in practical use. For example, chloride salts corrode machinery, emulsified asphalt contaminates underground water, and some resins and polymers are not environmentally friendly [2, 4]. Because of these concerns, watering without the additives is the most acceptable dust control method despite of the quick evaporation disadvantage.

To overcome this obstacle, the inventors modified certain polymers to maintain liquid states in ambient conditions while enhancing the wetting states of dust particle; thus mimicking the effect of watering with significantly enhanced wetting conditions. The inventors surprisingly discovered environmentally-friendly dust suppressant polymer blend formulations.

The inventors also discovered that certain “liquid” polymers enhances the wetting state, and that certain amphiphilic polymers enhances the agglomeration state of dust particles and enhance hydrophobic dust to mix with, or immerse into a diluting agent (such as water). These amphiphilic polymers were also useful to reduce the viscosity of HPMC (an exemplary cellulose ethers). Additionally, the inventors discovered that “cellulose” (provided in the form of cellulose ether) significantly enhances the agglomeration states of dust particles. For example, liquid polymer+cellulose (HPMC) mixture was found to immerse and significantly enhance the agglomeration of hydrophobic dust (synergistic effect). Furthermore, after evaporation of water, dust suppression ability was significantly increased by the liquid polymer+cellulose (HPMC) mixture compared to each is used separately (synergistic effect).

This background information is provided for the purpose of making information believed by the applicant to be of possible relevance to the present invention. No admission is necessarily intended, nor should it be construed, that any of the preceding information constitutes prior art against the present invention.

### BRIEF DESCRIPTION OF THE FIGURES

FIG. 1. Home-made air-blowing test apparatus. Various compressed air pressure can be applied to the sample surface. The dust sensor records PM2.5 and PM10 concentrations (μg/m³) in real time on top of the closed chamber. After the measurement, an anemometer, located at the sample surface, is utilized to convert the air pressure to wind speed.

FIG. 2. Air-blowing test on dust samples from mine tailings (i.e. rock particles). PM10 and PM2.5 concentrations in air are measured after the water evaporation. A and B denote L62 and HPMC, respectively. 5 and 01 mean 5% and 0.1% in water. Wind speed on the sample surface: 110 km/h

FIG. 3. Viscosity of dust suppressant formulations as a function of shear rates. Complex viscosity was measured by using rheometer at 25° C. (1 mPa·s=1 cps)

FIG. 4. Lab scale air-blowing test on soil dust sample. PM10 and PM2.5 concentrations in air are measured after the water evaporation. A and B denote L62 and HPMC, respectively. 5, 1, 05 and 01 mean 5%, 1%, 0.5% and 0.1% in water, respectively. Wind speed on the sample surface: 50 km/h

FIG. 5. Sink tests of coal particles in water, 0.1% L62 formulation and polymer blend formulation composed of 0.1% HPMC and 0.1% L62.

FIG. 6. Home-made vortexing apparatus for coal dust emission measurement. Motor speed=1,500 rpm

FIG. 7. Coal dust measurement during vortexing dust suppressants-treated samples. PM10 and PM2.5 concentrations were measured by the dust sensor over an hour. The maximum values of each test were collected (n=3). A and B denote L62 and HPMC, respectively. 01 denote 0.1 w/v % of polymer in water.

FIG. 8. Lab scale air-blowing test on coal dust sample after the vortexing experiment. PM10 and PM2.5 concentration in air are measured after the vortexing experiment. A and B denote L62 and HPMC, respectively. 01 denote 0.1 w/v % of polymer in water. Wind speed on the sample surface: 50 km/h

FIG. 9. Thermogravimetric analysis of coal dust samples after the application of no water, water alone, L62 aqueous solution and L62-HPMC polymer blend aqueous solution. Self-heating rate (ΔW; %) are calculated by subtracting the maximum and the minimum between 100 and 270° C. where water evaporation and oxygen adsorption to coal particles occur respectively. A and B denote L62 and HPMC, respectively. 1 and 005 denote 1 and 0.05 w/v % of polymers in water, respectively.

FIG. 10. Sink tests of subway dust particles in water, 0.1% L62 formulation and polymer blend formulation composed of 0.1% HPMC and 0.1% L62.

FIG. 11. Lab scale air-blowing test on subway dust samples treated by developed formulations. PM10 and PM2.5 concentration in air were measured after a week (n=3). A and B denote L62 and HPMC. 005, 01, 1, 3 and 5 denote 0.05, 0.1, 1, 3 and 5 w/v % of polymer in water, respectively. Wind speed on the sample surface: 50 km/h

FIG. 12. Lab scale air-blowing test on subway dust samples treated by developed formulations and dried for 8 weeks. PM10 and PM2.5 concentration in air were measured (n=3). A and B denote L62 and HPMC. 005, 01, 1, 3 and 5 denote 0.05, 0.1, 1, 3 and 5 w/v % of polymer in water, respectively. Wind speed on the sample surface: 50 km/h

FIG. 13. Lab scale air-blowing test on subway dust samples treated by developed formulations and dried for 8 weeks. PM10 and PM2.5 concentration in air were measured (n=3). A and B denote L62 and HPMC. 005, 01, 1, 3 and 5 denote 0.05, 0.1, 1, 3 and 5 w/v % of polymer in water, respectively. Data of disrupted samples by applying compressed air (30 psi) were not included (A3 and A3B01) since the data is out of range that can be detected by the sensor. Wind speed on the sample surface: 80 km/h.

FIG. 14. Lab scale air-blowing test on subway dust samples to compare the effect between liquid and solid amphiphilic polymers. PM10 and PM2.5 concentrations in air were measured after a week (n=3). A, B, and F denote L62, HPMC, and F127, wherein L62 and F127 represent liquid amphiphilic polymer and solid amphiphilic polymer, respectively. 005 and 3 denote 0.05 and 3 w/v % of polymers in water. Wind speed on the sample surface: 50 km/h

FIG. 15. Microscope images of various polymer formulations on the glass plate after drying at 40° C. for 3 days. The magnitudes are ×400 (left large image) and ×1000 (right four small images).

### DETAILED DESCRIPTION

### 1.0. Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±20% variation from the nominal value. It is to be understood that such a variation is always included in any given value provided herein, whether or not it is specifically referred to.

As used herein, the term “HPMC” refers to hydroxypropyl methylcellulose. HPMC is used interchangeably with the term “hypromellose”. Hypromellose (INN), short for hydroxypropyl methylcellulose (HPMC). HPMC is started from cellulose biopolymer and treated with chemicals to introduce methoxy or methyl groups and increase water solubility. HPMC has high viscous property, utilized as a thickening agent, or adhesives. Furthermore, due to its biocompatibility, HPMC is utilized as eye drops, an excipient for deliver hydrophobic drug and also used as a food additive, and an alternative to gelatin.

Herein, the term “biocompatible liquid polymer” is used interchangeably with the term “liquid polymer” to refer to “liquid amphiphilic polymer”.

Herein, the term “cellulose biopolymer” is used herein to refer to the term “cellulose ether” (as exemplified by HPMC).

The major benefit of liquid polymers for dust control is maintaining moisture content like the purpose of watering while the moisture content maintained by the liquid polymer is continuing more than several months. The inventors surprisingly discovered environmentally-friendly dust suppressant polymer blend formulations. This formulation may comprise liquid amphiphilic polymer, such as L62 (CAS reg. no.: 9003-11-6), and cellulose biopolymer, such as HPMC (CAS reg. no.: 9004-65-3). Both L62 and HPMC are cleared for both food and nonfood use.

The terms “polymer blend formulation”, “polymer blend”, “blend formulation” and “developed polymer formulations” is used herein to refer generally to the compositions and concentrates of the invention.

The term “dust suppression” encompasses dust mitigation and dust control.

Herein, the term “L62” is used interchangeably with the term “poloxamer 182” and “Pluronic L62” to refer to L62 (CAS reg. no.: 9003-11-6).

The term “diluting agent” as used herein includes water. Other diluting agents that may be used include sea water and aqueous solutions with chlorides such as MgCl₂, CaCl₂ and NaCl.

The term “polymer blend” as used herein refers to a concentrate (liquid or solid) or a composition of the invention comprising a cellulose ether and a liquid amphiphilic polymer.

Cellulose Ether

Cellulose ethers are polymers produced by the chemical modification of cellulose. In some embodiments, the cellulose ethers used in the invention may be chosen from carboxymethylcellulose (CMC) and derivatives, methylcellulose (MC) and derivatives, hydroxyethylcellulose (HEC) and derivatives, ethylcellulose (EC) and derivatives, and hydroxyethyl methylcellulose (HEMC) and derivatives.

Liquid Amphiphilic Polymer

The term “liquid amphiphilic polymer” as used herein may include those polymers disclosed in Provisional Patent U.S. Application No. 62/652,250 and PCT Application No.: PCT/US2018/055466. In some embodiments, liquid amphiphilic block copolymer may be used in the compositions and concentrates of the invention. In further embodiments, Poloxamer liquid or Pluronic liquid (e.g. Poloxamer 181 or Pluronic L61, Poloxamer 182 or Pluronic L62, or Pluronic L92). In some embodiments, liquid block copolymer composed of polyethylene glycol (PEG), also known as polyethylene oxide (PEO) and polypropylene glycol (PPG), also known as Polypropylene oxide (PPO), Polyoxypropylene, 2-(2-hydroxypropoxy)propan-1-ol, Emkapyl, Lineartop E, Niax ppg, or derivatives thereof may be used in the invention. For example, liquid amphiphilic polyethylene oxide-polypropylene oxide-polyethylene oxide, PEO-PPO-PEO (also known as “liquid Poloxamer”, “liquid Pluronic”) maybe used in the invention.

### Concentrates

One aspect of the invention pertains to concentrated formulations (“concentrates”) for easy transportation. These concentrates may be in a liquid, solid, semi-solid or gel form. The invention encompasses concentrates where a miniscule, or a negligible, amount of water is present. The concentrates of the invention may be combined with at least a diluting agent (e.g., water) to prepare compositions that may be used for dust control or dust suppression.

Liquid concentrates can be prepared, without water (#1) or with water (#2):

1. In some embodiments, liquid concentrates may have a volume ratio of cellulose ether (e.g., HPMC) to liquid amphiphilic polymer (e.g., L62) of 1:at least 5. These polymer blend concentrates will already exist as a liquid.

2. In other embodiments, the polymer blend from #1 can be mixed with water in a ratio ranging from about 1:0 to about 1:1 to obtain a diluted liquid concentrate.

Furthermore, solid concentrates can be prepared with water in the following ratios (#3 and #4):

3. In some embodiments, solid concentrates may have a volume ratio of cellulose ether (e.g., HPMC) to liquid amphiphilic polymer (e.g., L62) of 1:less than 5. This is already a solid concentrate.

4. The solid concentrates from #3 can be mixed with water in a ratio of about 0 to about 3 (concentrate:water). Any ratio of 0 to less than or equal to 3 (concentrate:water) will be a solid.

In some embodiments, the invention pertains to a method of making a concentrated dust suppression composition, said method comprising combining a cellulose ether, a liquid amphiphilic polymer, and water. These concentrates may be diluted for final application for dust suppression depending on the dust types. For example, once diluted the solution may be used in a spray system for dust suppression. In some instances, a very dilute composition may be used for the dust mitigation.

For example, liquid concentrates may be prepared by a method comprising:
(a) adding a cellulose ether (e.g., HPMC powder) in an amount ranging from about 0.01% to about 10% to a liquid amphiphilic polymer (up to about 50%);
(b) keep the mixture until the cellulose ether is immersed with liquid amphiphilic polymer to obtain a cellulose ether-liquid amphiphilic polymer mixture;
(c) stirring said a cellulose ether-liquid amphiphilic polymer mixture (e.g., via mechanical means);
(d) adding water to the mixture (up to remained percentage). Stirring said a cellulose ether-liquid amphiphilic polymer-water mixture (e.g. via mechanical means);

Solid concentrates may be prepared by a method comprising:
(a) adding a cellulose ether (e.g., HPMC powder) (in an amount up to 50%) to a liquid amphiphilic polymer (up to about 50%);
(b) adding about 0 to about 3 times volume of water to the mixture;
(c) blend said the cellulose ether and the liquid amphiphilic polymer together (e.g., via mechanical means);
(d) dry mixture to remove water until the viscous liquid converted into a solid concentrate or solid pellets
When preparing solid concentrates, water is typically only used for assisting blending process, and then the water can be removed by the evaporation after the blending process.

In some embodiments, the invention pertains to a method of preparing a composition (e.g., dust suppression composition) comprising contacting (e.g., via mixing) a solid concentrate comprising a cellulose ether and a liquid amphiphilic polymer with a diluting agent (e.g., water). Water may be used for assisting blending process, and then the water can be removed by the evaporation after the blending process. In some embodiments, the solid concentrate has less than 1 wt % of water. The solid concentrate may also have less than 0.5 wt % of water, less than 0.1 wt % of water, or less than 0.01 wt % of water. Furthermore, solid concentrates of the invention may range from having no water in the polymer blend comprising cellulose ether and liquid amphiphilic polymer to having 75% water with 25% polymer blend (i.e., cellulose ether:liquid amphiphilic polymer=1:3).

In further embodiments, the invention pertains to a method of preparing a composition (e.g., dust suppression composition) comprising contacting (e.g., via mixing) a liquid concentrate comprising a cellulose ether, a liquid amphiphilic polymer, and water, wherein the ratio of water to liquid amphiphilic polymer is 1:1, with a diluting agent (e.g., water).

In some embodiments, the invention pertains to a solid concentrate comprising a cellulose ether and a liquid amphiphilic polymer (water is used for assisting blending process, and then the water can be removed by the evaporation after the blending process). The solid concentrate may comprise up to about 50.0 to 85.1% of a liquid amphiphilic polymer and up to about 14.9 to 50.0% of a cellulose ether (e.g. HPMC). In further embodiments, the invention pertains to a composition with the following ratio in the range of about 5:1 ratio to about 1:1 ratio of a liquid amphiphilic polymer to a cellulose ether (e.g. HPMC).

For example, the invention pertains to a concentrate comprising liquid amphiphilic polymer and a cellulose ether (e.g. HPMC), wherein liquid amphiphilic polymer and a cellulose ether are present in the range of about 83.3% liquid amphiphilic polymer:about 16.7% cellulose ether (e.g. HPMC) (i.e., a 5:1 ratio) to 50% liquid amphiphilic polymer:about 50% cellulose ether (e.g. HPMC) (i.e., a 1:1 ratio).

In some embodiments, the solid concentrate comprises cellulose ether, liquid amphiphilic polymer, and water in a ratio of at least 1:1:0, respectively. Further, cellulose ether, liquid amphiphilic polymer, and water may be present in any of the following ratios:

cellulose ether, liquid amphiphilic polymer, and water may be present in a ratio of at least 1:1:1, respectively;

cellulose ether, liquid amphiphilic polymer, and water may be present in a ratio of at least 1:1:2, respectively; or

cellulose ether, liquid amphiphilic polymer, and water may be present in a ratio of at least 1:1:3, respectively.

The invention also pertains to a liquid concentrate comprising a cellulose ether, a liquid amphiphilic polymer, and water, wherein the ratio of water to liquid amphiphilic polymer is 1:1. In other means, the same ratio of water to liquid polymer is added for better blending. HPMC ratio can be varied

In some embodiments, the liquid concentrate may comprise at least 46.2% of a liquid amphiphilic polymer, at least 46.2% of water and up to 7.7% of a cellulose ether (e.g. HPMC). In further embodiments, the invention encompasses a liquid concentrate comprises a cellulose ether and a liquid amphiphilic polymer in a ratio in the range of about 6:1 ratio to about 500:1 ratio of a liquid amphiphilic polymer to a cellulose ether (e.g. HPMC).

For example, the invention pertains to a composition comprising liquid amphiphilic polymer, a cellulose ether (e.g. HPMC) and water, wherein liquid amphiphilic polymer, a cellulose ether and water are present in the range of about 46.2% liquid amphiphilic polymer:about 7.7% cellulose ether (e.g. HPMC):about 46.2% water (i.e., a 6:1 ratio) to about 50% liquid amphiphilic polymer:about 0.1% cellulose ether (e.g. HPMC):about 50% water (i.e., 500:1 ratio). The solid concentrate may comprise liquid amphiphilic polymer and cellulose ether in any of one of the following ratios:

about 50.0% of liquid amphiphilic polymer and about 50.0% of cellulose ether;

about 52.6% of liquid amphiphilic polymer and about 47.4% of cellulose ether;

about 55.6% of liquid amphiphilic polymer and about 44.4% of cellulose ether;

about 58.8% of liquid amphiphilic polymer and about 41.2% of cellulose ether;

about 62.5% of liquid amphiphilic polymer and about 37.5% of cellulose ether;

about 66.7% of liquid amphiphilic polymer and about 33.3% of cellulose ether;

about 69.0% of liquid amphiphilic polymer and about 31.0% of cellulose ether;

about 71.4% of liquid amphiphilic polymer and about 28.6% of cellulose ether;

about 74.1% of liquid amphiphilic polymer and about 25.9% of cellulose ether;

about 75.0% of liquid amphiphilic polymer and about 25.0% of cellulose ether;

about 76.9% of liquid amphiphilic polymer and about 23.1% of cellulose ether;

about 78.9% of liquid amphiphilic polymer and about 21.1% of cellulose ether;

about 80.0% of liquid amphiphilic polymer and about 20.0% of cellulose ether;

about 81.1% of liquid amphiphilic polymer and about 18.9% of cellulose ether;

about 81.6% of liquid amphiphilic polymer and about 18.4% of cellulose ether;

about 83.3% of liquid amphiphilic polymer and about 16.7% of cellulose ether;

about 84.1% of liquid amphiphilic polymer and about 15.3% of cellulose ether;

or

about 85.1% of liquid amphiphilic polymer and about 14.9% of cellulose ether.

In some embodiments, the liquid concentrate of the invention comprises about 46.2% of liquid amphiphilic polymer, about 7.7% of cellulose ether, and about 46.2% of water.

In some embodiments, the liquid concentrate of the invention comprises about 46.3% of liquid amphiphilic polymer, about 7.4% of cellulose ether, and about 46.3% of water.

In some embodiments, the liquid concentrate of the invention comprises about 46.5% of liquid amphiphilic polymer, about 7.0% of cellulose ether, and about 46.5% of water.

In some embodiments, the liquid concentrate of the invention comprises about 46.7% of liquid amphiphilic polymer, about 6.5% of cellulose ether, and about 46.7% of water.

In some embodiments, the liquid concentrate of the invention comprises about 46.9 to about 47.3% of liquid amphiphilic polymer, about 5.3 to about 6.3% of cellulose ether, and about 46.9 to about 47.3% of water.

In some embodiments, the liquid concentrate of the invention comprises about 47.6% of liquid amphiphilic polymer, about 4.8% of cellulose ether, and about 47.6% of water.

In some embodiments, the liquid concentrate of the invention comprises about 47.8 to about 48.0% of liquid amphiphilic polymer, about 4.0 to about 4.8% of cellulose ether, and about 47.8 to about 48.0% of water.

In some embodiments, the liquid concentrate of the invention comprises about 48.1 to about 48.6% of liquid amphiphilic polymer, about 2.7 to about 3.7% of cellulose ether, and about 48.1 to about 48.6% of water.

In some embodiments, the liquid concentrate of the invention comprises about 48.8 to about 49.0% of liquid amphiphilic polymer, about 2.0 to about 2.4% of cellulose ether, and about 48.8 to about 49.0% of water.

In some embodiments, the liquid concentrate of the invention comprises about 49.1 to about 50% of liquid amphiphilic polymer, 0.0 to about 1.8% of cellulose ether, and about 49.1 to about 50% of water.

Cellulose ether that may be used include hydroxypropyl methylcellulose, also known as hypromellose, or HPMC. The cellulose ether (e.g. HPMC) may have viscosity of about 300,000 cps or less, or a viscosity of about 200,000 cps or less, or a viscosity of about 100,000 cps or less.

In some instances, the invention encompasses a concentrate comprising liquid amphiphilic polymer and a cellulose ether (e.g. HPMC), wherein the liquid amphiphilic polymer and the cellulose ether are present as follows:

from 5% liquid amphiphilic polymer+0.01% a cellulose ether (e.g. HPMC) (i.e., 500:1 ratio) to 0.1% liquid amphiphilic polymer+0.1% a cellulose ether (e.g. HPMC) (i.e., 1:1 ratio). In short, the invention encompasses a concentrate with the following ratio in the range of about 500:1 ratio to about 1:1 ratio of a liquid amphiphilic polymer to a cellulose ether (e.g. HPMC).

The invention also encompasses a concentrate with a ratio in the range of about 500:1 ratio to about 1:1 ratio of a liquid amphiphilic polymer to a cellulose ether (e.g. HPMC).

The solid or liquid concentrate may be diluted in water for use in dust suppression method (e.g., preparation of a spray composition). For instance, the solid or liquid concentrate may be diluted in water for the final use (e.g., in dust suppression) as follows:

liquid amphiphilic polymer: 5% or less
cellulose ether (e.g. HPMC): 0.1% or less
water as a diluting agent: other remaining %

For example (applying the foregoing formulae):

liquid amphiphilic polymer: 5%
cellulose ether (e.g. HPMC): 0.1%
water as a diluting agent: 94.9%

### Compositions

A diluting agent, such as water, is an optional element for either solid or liquid concentrates. To facilitate concentration processing, water can be added as in 0-3 volume ratio to any type polymer blends, e.g. solid concentrates (comprising cellulose ether (such as HPMC):liquid amphiphilic polymer=1:<5) and also liquid concentrates (comprising cellulose ether (such as HPMC):liquid amphiphilic polymer=1:>=5). One aspect of the invention pertains to a dust suppression composition comprising a cellulose ether and a liquid amphiphilic polymer. In some embodiments, the dust suppression composition further comprises a diluting agent, e.g. a diluting agent.

Another aspect of the invention pertains to a dust suppression composition comprising a cellulose ether and a liquid amphiphilic polymer, wherein:
said cellulose ether is present in an amount ranging from about 0.01% to about 0.1%;
said liquid amphiphilic polymer is present in an amount ranging from about 0.1% to about 5%;
said water as a diluting agent is present in an amount ranging from about 94.9% to about 99.89%; and
wherein said amounts are based on the total weight of the composition.

In some embodiments, the cellulose ether is hydroxypropyl methylcellulose (HPMC). The HPMC may have viscosity of about 10,000 to about 300,000 cps. Further, HPMC may have viscosity of about 300,000 cps or less, or about 200,000 cps or less, or about 100,000 cps or less.

In some embodiments, the liquid amphiphilic polymer is poloxamer 182 (also known as Pluronic L62) or liquid amphiphilic block copolymers composed of polyethylene oxide (PEO) or polyethylene glycol (PEG) and polypropylene oxide (PPO) or polypropylene glycol (PPG).

Method

Another aspect of the invention pertains to a method of preparing a concentrated dust suppression composition comprising mixing cellulose ether, a liquid amphiphilic polymer and water, then drying the mixture to obtain said solid concentrate.

For example, a concentrated dust suppression composition may be prepared using a method comprising mixing cellulose ether, a liquid amphiphilic polymer and water to obtain said liquid concentrate.

The invention encompasses a dust suppression composition comprising cellulose ether and a liquid amphiphilic polymer and water as a diluting agent, wherein viscosity of the dust suppression composition is less than 100 cps. In some embodiments, these dust suppression compositions comprise 0.1% HPMC and 0.1% L62, or 0.1% HPMC and 0.5% L62. The compositions and concentrates of the invention may be used to suppress dust (e.g., subway dust, coal dust, mine tailing dust and ground dust) by coating said dust particles.

In some embodiments, the method of suppressing subway dust comprises contacting a composition comprising 1 to 5% of liquid amphiphilic polymer, 0.01 to 0.1% of HPMC, and at least 94.9% of water, with said dust.

Furthermore, the invention encompasses a method of suppressing coal dust comprising contacting a composition comprising 0.1 to 1% of liquid amphiphilic polymer, 0.01 to 0.1% of HPMC, and at least 98.9% of water, with said dust.

Additionally, the invention pertains to a method of suppressing mine tailing dust comprising contacting a composition comprising 0.1 to 5% of liquid amphiphilic polymer, 0.01 to 0.1% of HPMC, and at least 94.9% of water, with said dust.

In some embodiments, the invention encompasses a method of suppressing ground dust comprising contacting a composition comprising 0.1 to 5% of liquid amphiphilic polymer, 0.01 to 0.1% of HPMC, and at least 94.9% of water, with said dust.

The compositions of the invention (e.g., dust suppression composition) may be prepared by a method comprising contacting (e.g., via mixing) a solid or liquid concentrate of the invention with a diluting agent (e.g., water).

Another aspect of the invention pertains to a method of suppressing dust, said method comprising contacting a composition according to a dust suppression composition comprising a cellulose ether and a liquid amphiphilic polymer.

A further aspect of the invention pertains to a method of suppressing dust, said method comprising contacting said dust with a dust suppression composition comprising a cellulose ether and a liquid amphiphilic polymer, wherein:
a. said cellulose ether is present in an amount ranging from about 0.01% to about 0.1%;
b. said liquid amphiphilic polymer is present in an amount ranging from about 0.1% to about 5%;
c. said water as a diluting agent is present in an amount ranging from about 94.9% to about 99.89%; and
d. wherein said amounts are based on the total weight of the composition.

Concentrated dust suppression composition may be made by a method comprising combining cellulose ether, a liquid amphiphilic polymer, and a water. For instance, concentrated dust suppression composition may be made by a method comprising
(a) Adding both a cellulose ether (such as HPMC) and a liquid amphiphilic polymer in the weight ratio of about 1:1 to about 1:700;
(b) Keep the mixture until the cellulose ether is immersed with liquid amphiphilic polymer;
(c) Stir the mixture (e.g., via mechanical means);
(d) Add same amount of water with the amount of liquid amphiphilic polymer (liquid amphiphilic polymer:water=1:0-3 ratio);
(e) Stir the mixture (e.g., via mechanical means);
(f) Dry the mixture in the electric oven (This step can be applied to prepare for solid concentrate. For liquid concentrates, this step (d)-(f) can be omitted entirely.)
(g) obtain said a concentrated dust suppression composition, wherein said a concentrated dust suppression composition is solid concentrate or liquid concentrate.

### List of Embodiments

1. A dust suppression composition comprising a cellulose ether and a liquid amphiphilic polymer.
2. The dust suppression composition according to embodiment 1, wherein said composition further comprises water as a diluting agent.
3. The dust suppression composition according to embodiment 1, wherein:
   (a) said cellulose ether is present in an amount ranging from about 0.01% to about 0.1%;
   (b) said liquid amphiphilic polymer is present in an amount ranging from about 0.1% to about 5%;
   (c) said water as a diluting agent is present in an amount ranging from about 94.9% to about 99.89%; and
   (d) wherein said amounts are based on the total weight of the composition.
4. The dust suppression composition according to embodiment 1, wherein said cellulose ether is hydroxypropyl methylcellulose (HPMC).
5. The dust suppression composition according to embodiment 4, wherein said HPMC has a viscosity of about 10,000 to about 300,000 cps.
6. The dust suppression composition according to embodiment 4, wherein said HPMC has a viscosity of about 300,000 cps or less.
7. The dust suppression composition according to embodiment 4, wherein said HPMC has a viscosity of about 200,000 cps or less.
8. The dust suppression composition according to embodiment 4, wherein said HPMC has a viscosity of about 100,000 cps or less.
9. The dust suppression composition according to embodiment 1, wherein said liquid amphiphilic polymer is poloxamer 182 (also known as Pluronic L62) or liquid amphiphilic block copolymers composed of polyethylene oxide (PEO) or polyethylene glycol (PEG) and polypropylene oxide (PPO) or polypropylene glycol (PPG).
10. A method of suppressing dust, said method comprising contacting a composition according to embodiment 1 or embodiment 3.
11. A method of making a concentrated dust suppression composition, said method comprising combining cellulose ether, a liquid amphiphilic polymer, and a water.
   In some instances, the invention encompasses a concentrate comprising liquid amphiphilic polymer and a cellulose ether (e.g. HPMC), wherein the liquid amphiphilic polymer and the cellulose ether are present as follows:
   from 5% liquid amphiphilic polymer+0.01% a cellulose ether (e.g. HPMC) (i.e., 500:1 ratio) to 0.1% liquid amphiphilic polymer+0.1% a cellulose ether (e.g. HPMC) (i.e., 1:1 ratio). In short, the invention encompasses a concentrate with the following ratio in the range of about 500:1 ratio to about 1:1 ratio of a liquid amphiphilic polymer to a cellulose ether (e.g. HPMC).
   The invention therefore encompasses a concentrate with the following ratio in the range of about 500:1 ratio to about 1:1 ratio of a liquid amphiphilic polymer to a cellulose ether (e.g. HPMC).
12. The method of embodiment 11, wherein said method comprises
   (h) Adding both a cellulose ether (such as HPMC) and a liquid amphiphilic polymer in the weight ratio of about 1:1 to about 1:700;
   (i) keep the mixture until the cellulose ether is immersed with liquid amphiphilic polymer;
   (j) Stir the mixture (e.g., via mechanical means);
   (k) Add same amount of water with the amount of liquid amphiphilic polymer (liquid amphiphilic polymer:water=1:0-3 ratio);
   (l) Stir the mixture (e.g., via mechanical means);
   (m) Dry the mixture in the electric oven (This step can be applied to prepare for solid concentrate. For liquid concentrates, this step (d)-(f) can be omitted entirely.)
   (n) obtain said a concentrated dust suppression composition, wherein said a concentrated dust suppression composition is solid concentrate or liquid concentrate.
   The solid or liquid concentrate may be diluted in water for use in dust suppression method (e.g., preparation of a spray composition). For instance, the solid or liquid concentrate may be diluted in water for the final use (e.g., in dust suppression) as follows:
      liquid amphiphilic polymer: 5% or less
      cellulose ether (e.g. HPMC): 0.1% or less
      water as a diluting agent: other remaining %
   For example (applying the foregoing formulae):
      liquid amphiphilic polymer: 5%
      cellulose ether (e.g. HPMC): 0.1%
      water as a diluting agent: 94.9%
13. A solid concentrate comprising a cellulose ether and a liquid amphiphilic polymer (water is used for assisting blending process, and then the water can be removed by the evaporation after the blending process).
   In some embodiments, the solid concentrate may comprise up to about 50.0 to 85.1% of a liquid amphiphilic polymer and up to about 14.9 to 50.0% of a cellulose ether (e.g. HPMC). In further embodiments, the invention pertains to a composition with the following ratio in the range of about 5:1 ratio to about 1:1 ratio of a liquid amphiphilic polymer to a cellulose ether (e.g. HPMC).
   For example, the invention pertains to a concentrate comprising liquid amphiphilic polymer and a cellulose ether (e.g. HPMC), wherein liquid amphiphilic polymer and a cellulose ether are present in the range of about 83.3% liquid amphiphilic polymer:about 16.7% cellulose ether (e.g. HPMC) (i.e., a 5:1 ratio) to 50% liquid amphiphilic polymer:about 50% cellulose ether (e.g. HPMC) (i.e., a 1:1 ratio).
14. A liquid concentrate comprising a cellulose ether, a liquid amphiphilic polymer, and water, wherein the ratio of water to liquid amphiphilic polymer is 1:1. In other means, the same ratio of water to liquid polymer is added for better blending. HPMC ratio can be varied.
   In some embodiments, the liquid concentrate may comprise at least 46.2% of a liquid amphiphilic polymer, at least 46.2% of water and up to 7.7% of a cellulose ether (e.g. HPMC). In further embodiments, the invention encompasses a liquid concentrate comprises a cellulose ether and a liquid amphiphilic polymer in a ratio in the range of about 6:1 ratio to about 500:1 ratio of a liquid amphiphilic polymer to a cellulose ether (e.g. HPMC).
   For example, the invention pertains to a composition comprising liquid amphiphilic polymer, a cellulose ether (e.g. HPMC) and water, wherein liquid amphiphilic polymer, a cellulose ether and water are present in the range of about 46.2% liquid amphiphilic polymer:about 7.7% cellulose ether (e.g. HPMC):about 46.2% Water (i.e., a 6:1 ratio) to about 50% liquid amphiphilic polymer:about 0.1% cellulose ether (e.g. HPMC):about 50% water (i.e., 500:1 ratio).
15. The concentrate of embodiment 13, where said concentrate comprises about 50.0% of liquid amphiphilic polymer and about 50.0% of cellulose ether.
16. The concentrate of embodiment 13, where said concentrate comprises about 52.6% of liquid amphiphilic polymer and about 47.4% of cellulose ether.
17. The concentrate of embodiment 13, where said concentrate comprises about 55.6% of liquid amphiphilic polymer and about 44.4% of cellulose ether.
18. The concentrate of embodiment 13, where said concentrate comprises about 58.8% of liquid amphiphilic polymer and about 41.2% of cellulose ether.
19. The concentrate of embodiment 13, where said concentrates comprise about 62.5% of liquid amphiphilic polymer and about 37.5% of cellulose ether.
20. The concentrate of embodiment 13, where said concentrate comprises about 66.7% of liquid amphiphilic polymer and about 33.3% of cellulose ether.
21. The concentrate of embodiment 13, where said concentrate comprises about 69.0% of liquid amphiphilic polymer and about 31.0% of cellulose ether.
22. The concentrate of embodiment 13, where said concentrate comprises about 71.4% of liquid amphiphilic polymer and about 28.6% of cellulose ether.
23. The concentrate of embodiment 13, where said concentrate comprises about 74.1% of liquid amphiphilic polymer and about 25.9% of cellulose ether.
24. The concentrate of embodiment 13, where said concentrate comprises about 75.0% of liquid amphiphilic polymer and about 25.0% of cellulose ether.
25. The concentrate of embodiment 13, where said concentrate comprises about 76.9% of liquid amphiphilic polymer and about 23.1% of cellulose ether.
26. The concentrate of embodiment 13, where said concentrate comprises about 78.9% of liquid amphiphilic polymer and about 21.1% of cellulose ether.
27. The concentrate of embodiment 13, where said concentrate comprises about 80.0% of liquid amphiphilic polymer and about 20.0% of cellulose ether.
28. The concentrate of embodiment 13, where said concentrates comprise about 81.1% of liquid amphiphilic polymer and about 18.9% of cellulose ether.
29. The concentrate of embodiment 13, where said concentrate comprises about 81.6% of liquid amphiphilic polymer and about 18.4% of cellulose ether.
30. The concentrate of embodiment 13, where said concentrate comprises about 83.3% of liquid amphiphilic polymer and about 16.7% of cellulose ether.
31. The concentrate of embodiment 13, where said concentrate comprises about 84.1% of liquid amphiphilic polymer and about 15.3% of cellulose ether.
32. The concentrate of embodiment 13, where said concentrate comprises about 85.1% of liquid amphiphilic polymer and about 14.9% of cellulose ether.
33. The concentrate of embodiment 13, where said cellulose ether, said liquid amphiphilic polymer, and said water are present in a ratio of at least 1:1:0, respectively.
34. The concentrate of embodiment 13, where said cellulose ether, said liquid amphiphilic polymer, and said water are present in a ratio of at least 1:1:1, respectively.
35. The concentrate of embodiment 13, where said cellulose ether, said liquid amphiphilic polymer, and said water are present in a ratio of at least 1:1:2, respectively.
36. The concentrate of embodiment 13, where said cellulose ether, said liquid amphiphilic polymer, and said water are present in a ratio of at least 1:1:3, respectively.
37. The concentrate of embodiment 14, where said concentrate comprises about 46.2% of liquid amphiphilic polymer, about 7.7% of cellulose ether, and about 46.2% of water.
38. The concentrate of embodiment 14, where said concentrate comprises about 46.3% of liquid amphiphilic polymer, about 7.4% of cellulose ether, and about 46.3% of water.
39. The concentrate of embodiment 14, where said concentrate comprises about 46.5% of liquid amphiphilic polymer, about 7.0% of cellulose ether, and about 46.5% of water.
40. The concentrate of embodiment 14, where said concentrate comprises about 46.7% of liquid amphiphilic polymer, about 6.5% of cellulose ether, and about 46.7% of water.
41. The concentrate of embodiment 14, where said concentrate comprises about 46.9 to about 47.3% of liquid amphiphilic polymer, about 5.3 to about 6.3% of cellulose ether, and about 46.9 to about 47.3% of water.
42. The concentrate of embodiment 14, where said concentrate comprises about 47.6% of liquid amphiphilic polymer, about 4.8% of cellulose ether, and about 47.6% of water.
43. The concentrate of embodiment 14, where said concentrate comprises about 47.8 to about 48.0% of liquid amphiphilic polymer, about 4.0 to about 4.8% of cellulose ether, and about 47.8 to about 48.0% of water.
44. The concentrate of embodiment 14, where said concentrate comprises about 48.1 to about 48.6% of liquid amphiphilic polymer, about 2.7 to about 3.7% of cellulose ether, and about 48.1 to about 48.6% of water.
45. The concentrate of embodiment 14, where said concentrate comprises about 48.8 to about 49.0% of liquid amphiphilic polymer, about 2.0 to about 2.4% of cellulose ether, and about 48.8 to about 49.0% of water.
46. The concentrate of embodiment 14, where said concentrate comprises about 49.1 to about 50% of liquid amphiphilic polymer, 0.0 to about 1.8% of cellulose ether, and about 49.1 to about 50% of water.
47. The embodiments 15-36 said solid concentrate of embodiment 13.
48. The embodiments 37-46 said liquid concentrate of embodiment 14.
49. The concentrate of any of the preceding embodiments wherein said cellulose ether is hydroxypropyl methylcellulose, also known as hypromellose, or HPMC.
50. The concentrate of any of embodiments 11-49, wherein said HPMC has a viscosity of about 300,000 cps or less.
51. The concentrate of any of embodiments 11-49, wherein said HPMC has a viscosity of about 200,000 cps or less.
52. The concentrate of any of embodiments 11-49, wherein said HPMC has a viscosity of about 100,000 cps or less.
53. The dust suppression composition according to embodiment 1, wherein said liquid amphiphilic polymer is poloxamer 182 (also known as Pluronic L62) or liquid amphiphilic block copolymers composed of polyethylene oxide (PEO) or polyethylene glycol (PEG) and polypropylene oxide (PPO) and polypropylene glycol (PPG).
54. A method of preparing a concentrated dust suppression composition comprising mixing cellulose ether, a liquid amphiphilic polymer and water, then drying the mixture to obtain said solid concentrate.
55. A method of preparing a concentrated dust suppression composition comprising mixing cellulose ether, a liquid amphiphilic polymer and water to obtain said liquid concentrate.
56. A dust suppression composition comprising a composition according to embodiment 1 and water as a diluting agent, wherein viscosity of the dust suppression composition is less than 100 cps. In some embodiments, these dust suppression compositions comprise 0.1% HPMC and 0.1% L62, or 0.1% HPMC and 0.5% L62.
57. The method of embodiment 9, where said dust is subway dust, coal dust, mine tailing dust or ground dust.
58. In embodiment 57, a method of suppressing subway dust comprising contacting a composition according to embodiment 1, wherein said a composition is 1 to 5% of liquid amphiphilic polymer, 0.01 to 0.1% of HPMC, and at least 94.9% of water, with said dust.
59. In embodiment 57, a method of suppressing coal dust comprising contacting a composition according to embodiment 1, wherein said a composition is 0.1 to 1% of liquid amphiphilic polymer, 0.01 to 0.1% of HPMC, and at least 98.9% of water, with said dust
60. In embodiment 57, a method of suppressing mine tailing dust comprising contacting a composition according to embodiment 1, wherein said a composition is 0.1 to 5% of liquid amphiphilic polymer, 0.01 to 0.1% of HPMC, and at least 94.9% of water, with said dust.
61. In embodiment 57, a method of suppressing ground dust comprising contacting a composition according to embodiment 1, wherein said a composition is 0.1 to 5% of liquid amphiphilic polymer, 0.01 to 0.1% of HPMC, and at least 94.9% of water, with said dust.
62. A method of preparing a composition (e.g., dust suppression composition) comprising contacting (e.g., via mixing) a concentrate of embodiment 13 or embodiment 14 with a diluting agent (e.g., water).
63. A solid concentrate comprising a cellulose ether and a liquid amphiphilic polymer, wherein said cellulose ether and said liquid amphiphilic is present in a ratio of 1:less than 5.
64. A liquid concentrate comprising a cellulose ether and a liquid amphiphilic polymer, wherein said cellulose ether and said liquid amphiphilic is present in a ratio of 1:greater than or equal to (i.e, >=) 5.
65. The liquid concentrate according to embodiment 64, further comprising water (e.g. for dilution), wherein said concentrate and said water is present in a ratio of ranging from about 1:0 to about 1:1 (to obtain a diluted liquid concentrate).
66. The solid concentrate according to embodiment 63, further comprising water (e.g. for dilution), wherein said concentrate and said water is present in a ratio of 1 to less than 3.
67. The solid concentrate according to embodiment 66, further comprising water, wherein said concentrate and said water is present in a ratio of 1 to less than 3.
68. The solid concentrate according to embodiment 67, further comprising water for dilution, wherein said concentrate and said water is present in a ratio of about 1 to less than 3.

When coal is transported to and from the coal yard, wind typically blows from the coal particles into the air. These small particles of coal remain suspended in the air. This suspension of very small particles in the air is commonly known as “fugitive coal dust”. Another issue in the coal stockpile is the spontaneous combustion of coal, caused by self-heating due to carbon oxidation process, which initiated by oxygen adsorption on coal surfaces. Use of compositions of the invention to coat coal particles can reduce the contact between coal surfaces and oxygen from the environment, resulting in less self-heating. Therefore, the environmentally-friendly polymer blend formulation of the invention is useful to control coal dust as well as mitigate spontaneous combustion of coal in diverse industry, such as coal mines, coal power plants, and steel mills.

One aspect of the invention pertains to a method of reducing fugitive coal dust comprising contacting coal particles (optionally prior to transportation) with a composition according to the invention, with said dust.

In some embodiments, the invention pertains to a method of suppressing fugitive coal dust, said method comprising contacting a composition comprising a cellulose ether and a liquid amphiphilic polymer, with said dust. The composition may include water as a diluting agent.

In other embodiments, the invention pertains to a method of suppressing fugitive coal dust, said method comprising contacting a composition comprising a cellulose ether and a liquid amphiphilic polymer, and wherein the amount of said dust is reduced such that the amount of said dust is less than when none of said composition is applied. The composition include water as a diluting agent.

Furthermore, some embodiments the composition used in the method of suppressing fugitive coal dust comprises:
a. cellulose ether (e.g., hydroxypropyl methylcellulose, hypromellose, or HPMC) in an amount ranging from about 0.01% to about 0.1%. The cellulose ether (e.g. HPMC) may have a viscosity of a viscosity of about 10,000 to about 300,000 cps.
b. liquid amphiphilic polymer in an amount ranging from about 0.1% to about 5%. Examples of liquid amphiphilic polymer that may be used in the composition include poloxamer 182 (also known as Pluronic L62) or liquid amphiphilic block copolymers composed of polyethylene oxide (PEO) or polyethylene glycol (PEG) and polypropylene oxide (PPO) or polypropylene glycol (PPG).
c. water in an amount ranging from about 94.9% to about 99.89%; and
d. wherein said amounts are based on the total weight of the composition.

Furthermore, in some embodiments the composition used in the method of suppressing fugitive coal dust comprises:
a. said cellulose ether is present in an amount of about 0.1%;
b. said liquid amphiphilic polymer is present in an amount of about 0.1%
c. said water is present in an amount ranging from about 94.9% to about 99.89%; and
d. wherein said amounts are based on the total weight of the composition.

Furthermore, in some embodiments the composition used in the method of suppressing fugitive coal dust comprises:
a. said cellulose ether is present in an amount of about 0.05%;
b. said liquid amphiphilic polymer is present in an amount of about 0.1%
c. said water is present in an amount ranging from about 94.9% to about 99.89%; and
d. wherein said amounts are based on the total weight of the composition. Examples of liquid amphiphilic polymer that may be used in these compositions include poloxamer 182 (also known as Pluronic L62) or liquid amphiphilic block copolymers composed of polyethylene oxide (PEO) or polyethylene glycol (PEG) and polypropylene oxide (PPO) or polypropylene glycol (PPG).

Examples of cellulose ether that may be used in these compositions include hydroxypropyl methylcellulose, hypromellose, or HPMC.

### 2.0 Examples

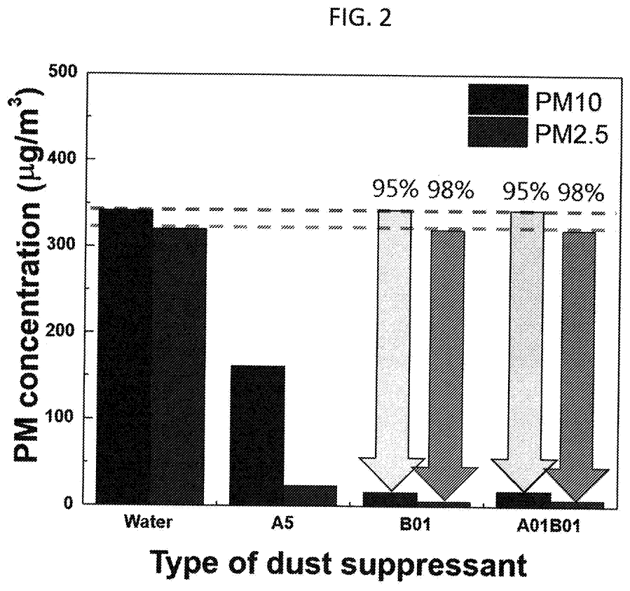

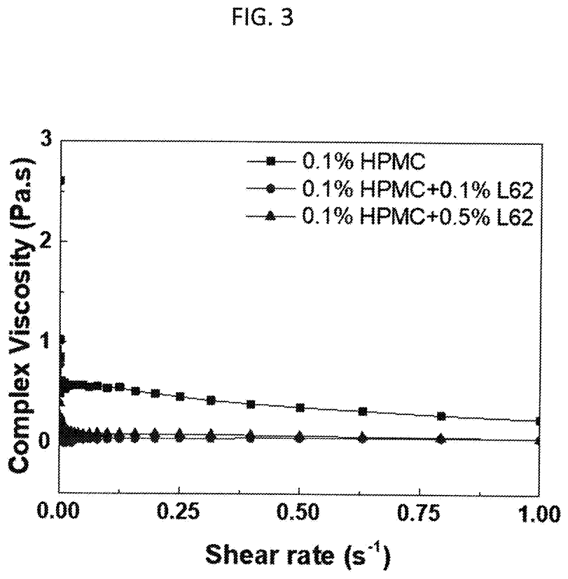

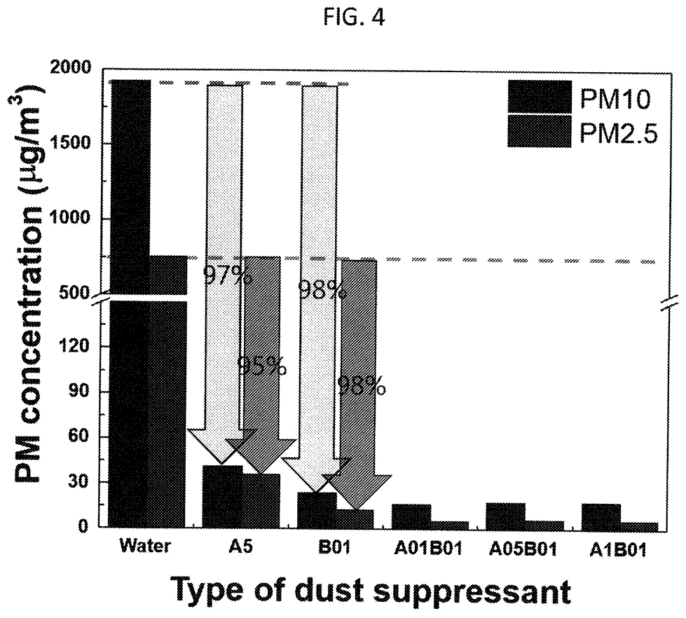

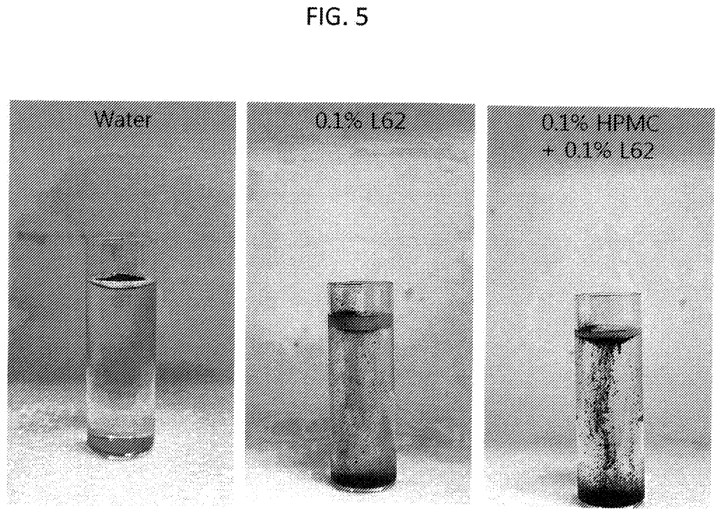

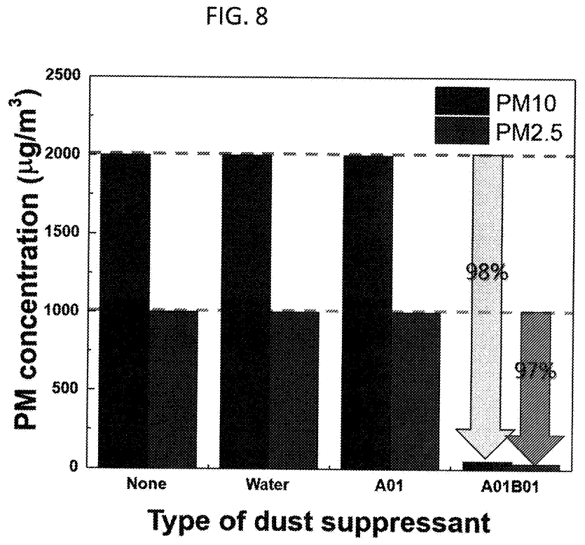

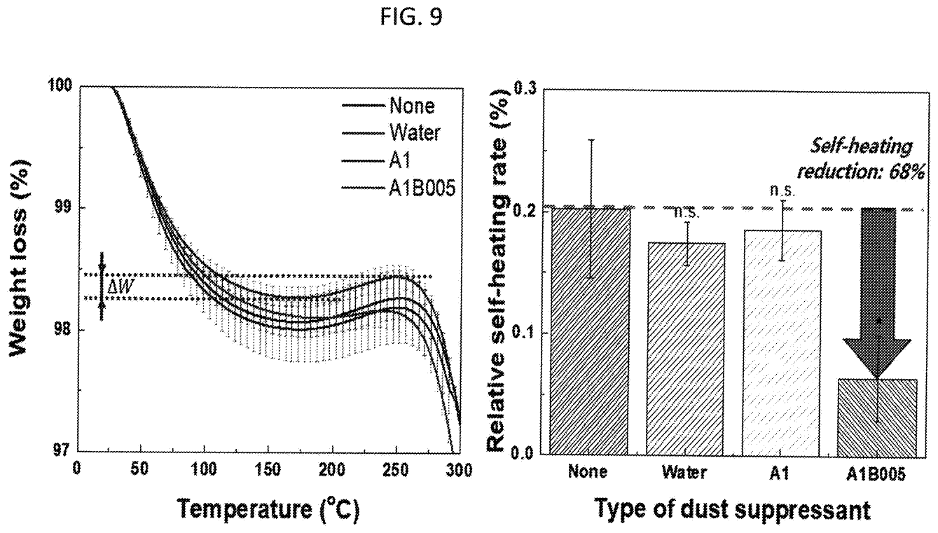

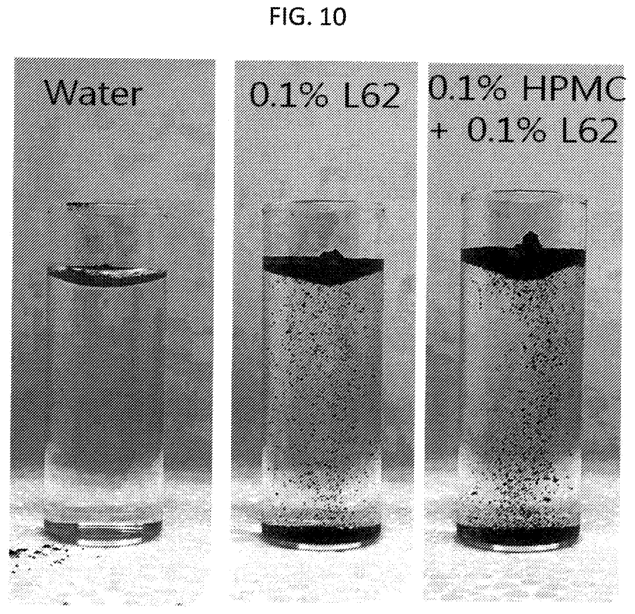

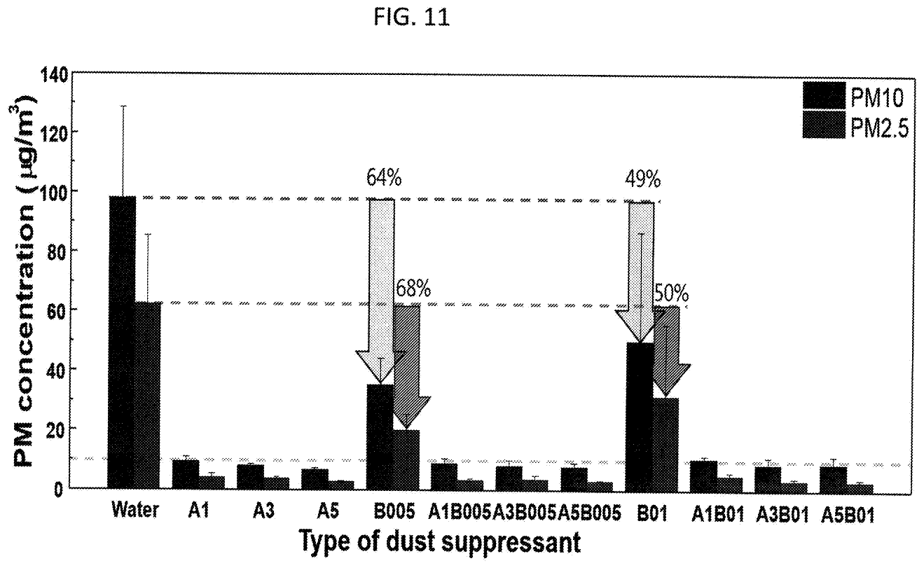

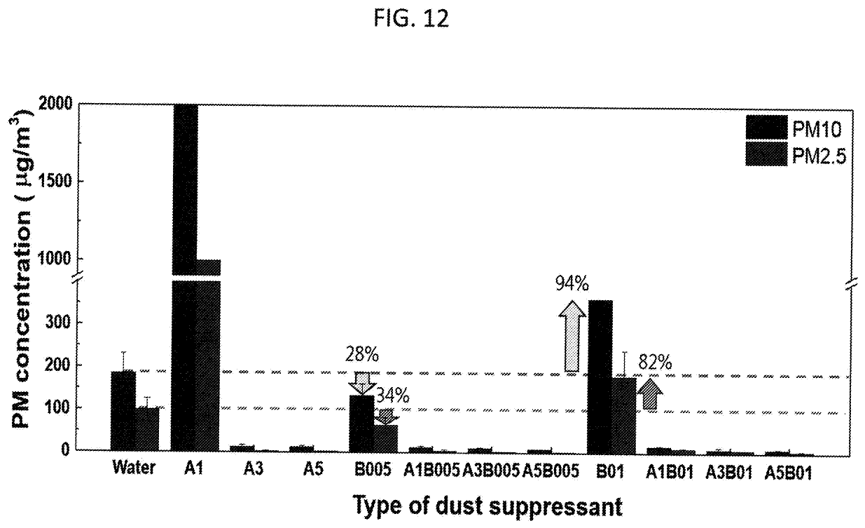

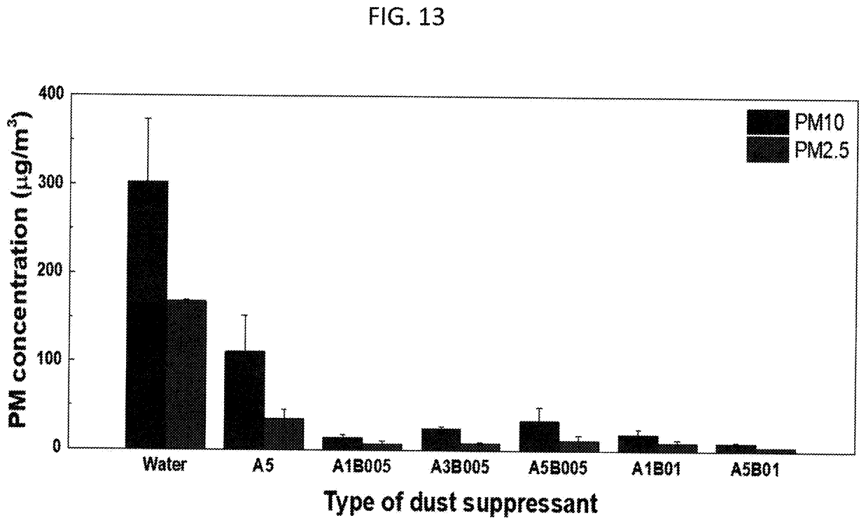

A polymer blend formulation (namely, an exemplary embodiment of the invention comprising L62 and HPMC) was applied to dust particles that were classified by whether the dust can be immersed into water or not. For the dust that can be immersed into water (e.g. mine tailings/rock particles or soil dust), the polymer blend maintained the moisture at dust sources by liquid polymer L62 and agglomerated the dust particles by both cellulose HPMC and amphiphilic polymer L62, resulting in effective dust suppression for more than two months (FIG. 2 and FIG. 4). For the dust that cannot be immersed into water (e.g. coal dust or subway dust), amphiphilic polymer L62 in the polymer blend allowed wetting hydrophobic particles into water and cellulose HPMC agglomerated particles to boost the immersion of hydrophobic particles into water (FIG. 5 and FIG. 10). The polymer blend formulations show the synergistic dust suppression effect on hydrophobic dusts (FIG. 8, FIG. 11, FIG. 12 and FIG. 13) because the stability of agglomerated particles is enhanced together with L62 and HPMC over two months (FIG. 13). In addition, less total polymer amounts are required for the polymer blend compared to the formulation with single polymers (FIG. 12 and FIG. 13), which is economically beneficial. Furthermore, unsprayable cellulose HPMC due to high viscosity may be converted to be sprayable by a common hand-held sprayer with the addition of amphiphilic polymer L62 (FIG. 3). As well as, the synergistic effect is observed when liquid amphiphilic polymer (e.g. Pluronic L62) is used for the blend formulations, whereas, the effect is disappeared when the blend formulations comprising a solid amphiphilic polymer (Pluronic F127) and HPMC. In addition to the aforementioned benefits of using polymer blend for dust suppression, the polymer blend can coat coal surface and reduce oxygen adsorption (FIG. 9), resulting in less self-heating and self-combustion in a coal stockpile.

Mine Tailings Dust Suppression

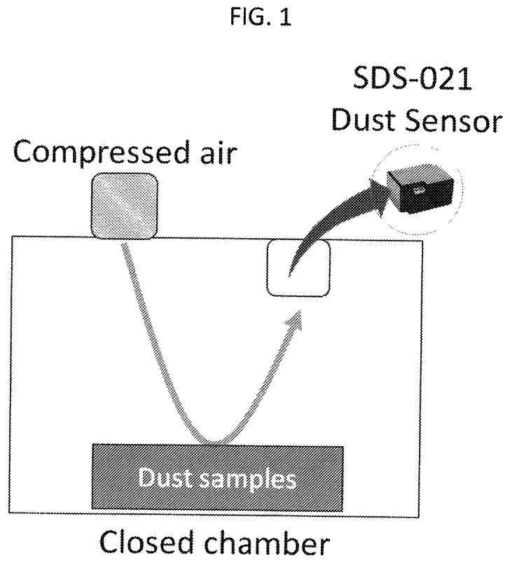

The dust suppression effectiveness of HPMC (viscosity=200,000 cps; 1 cps=1 mPa·s) was investigated by varying its concentrations in water and sprayed onto dried mine tailings dust, mainly composed of fine rock particles, and soil dust. Using USA standard 100 mesh sieve, particles smaller than 150 μm in a diameter were collected and used as dust samples. To investigate dust suppression effectiveness by HPMC formulation, L62- and water-treated samples were also prepared as control by spraying 15 mL of the solutions on top of dried dust samples (30 g). After drying the samples at 40° C. for 7 days, compressed air (50 psi) was applied directly on the sample surface (wind speed on the sample surface: 110 km/h), and monitor PM2.5 and PM10 concentrations in the home-made closed chamber (FIG. 1).

When HPMC of 0.1 w/v % in water applied to rock particle dust and dried, compared to the water-treated sample, dust concentrations of PM10 and PM2.5 were reduced by 95% and 98%, respectively (FIG. 2). Compared to the sample treated by 5 w/v % L62 in water, the dust concentrations of PM10 and PM2.5 were reduced 90% and 70%, respectively. The United States Environmental Protection Agency (EPA) Air Quality Index (AQI) indicates that the air quality in the chamber was in “Good” condition since PM10 and PM2.5 concentrations were dropped below 50 μg/m³ and 15 μg/m³, respectively. On the other hands, PM10 dust concentrations were in “Hazardous” or “Unhealthy” conditions and PM2.5 concentrations were in “Hazardous” or “Moderate” conditions when dust samples were treated by watering only or the L62 formulation. Therefore, it was found that the HPMC formulation can effectively suppress dusts from mine tailings or rock particles, which could be caused by the adhesive ability of HPMC, and provide clean air according to the AQI.

Despite of highly effective dust suppression by the low percentage of HPMC, its high viscosity can limit the practical use of HPMC formulation. It was discovered that 0.1% HPMC in water was difficult to spray using a typical hand-held sprayer and decided to quantify the viscosity of HPMC formulations, using rheometer. When shear rates were applied up to 1/s, the viscosity was 305.64±49.65 mPa·s, calculated by averaging viscosity values from 0.5/s to 1/s (FIG. 3). Viscosities of castor oil or motor oil SAE 40 are in similar ranges to the viscosity of 0.1 w/v % HPMC in water, which explains the reason that spraying the HPMC formulation is difficult using the hand-held sprayer. Note that the water viscosity is 1-5 mPa·s at room temperature.

Amphiphilic polymers, such as PEO-PPO-PEO block copolymers, including L62, are well-known as surfactant and dispersing agent, which can drop the viscosity of formulation. It was tested whether L62 can drop the viscosity of 0.1 w/v % HPMC in water. Concentrations of 0.1% and 0.5% of L62 was added in the HPMC formulation and measured the viscosity (FIG. 3). When 0.1% and 0.5% of L62 were mixed, the formulation viscosity dropped about six times (55.52±3.92 mPa·s) and four times (79.12±12.15 mPa·s), respectively, and we were able to spray the polymer mixture by the hand-held sprayer. Therefore, it was concluded that the combination of HPMC and L62 is beneficial for spraying the formulation using conventional water spray system.

If polymer mixture by both polymers are utilized because of the benefit in the viscosity, it is possible that dust reduction using the formulations composed of only L62 or HPMC in water can be negatively affected when both polymers are mixed in water and used together as a dust suppressant. To investigate whether the polymer mixture formulation can influence dust suppression, the formulation was onto the rock particle dust, dried the sample and conducted the tests (FIG. 2). By applying the compressed air on the sample, it was observed that the dust suppression ability by 0.1% HPMC was still maintained although 0.1% L62 was added in the HPMC formulation. Therefore, it was concluded that the polymer mixture of L62 and HPMC shows the advantage on dust control, can be easily sprayed by common water spray systems and suppresses mine tailings/rock particle dust that satisfy “Good” condition in the AQI standard.

Soil Dust Suppression

Additionally, the polymer blend formulation was applied to mitigate soil dust. Using USA standard 100 mesh sieve, soil particles smaller than 150 μm in a diameter were collected and used as soil dust samples. In addition to applying water, 5 w/v % L62 in water and 0.1 w/v % HPMC in water were sprayed to dust samples, polymer blend formulations, prepared by 0.1% HPMC with various concentrations of L62 in water, was also applied. After drying the samples at room temperature for more than a week, compressed air (20 psi) were directly applied on the sample surface (measured wind speed on the sample surface: 50 km/h), and PM2.5 and PM10 concentrations were measured in the closed chamber (FIG. 1).

When 5 w/v % L62, 0.1 w/v % HPMC and the polymer mixture in water were applied to soil dust and dried, compared to the water-treated sample, dust concentrations of PM10 and PM2.5 were reduced by more than 95% (FIG. 4). PM10 concentrations were dropped below 50 μg/m³, the “Good” air quality condition, when all three types of developed polymer formulations were applied to the samples. PM2.5 concentrations were dropped below 15 μg/m³ when HPMC and the polymer mixture were applied but the PM2.5 of only L62 was higher and indicated the air quality is in “Moderate” condition. Compared to the sample treated by only HPMC formulation, when the polymer mixtures were applied to the soil dust, PM10 and PM2.5 concentrations were reduced by 30% and 57%, respectively. This result suggests that the polymer mixture synergistically suppresses the soil dust, resulting in better dust control than the formulations composed of only 5 w/v % L62 or 0.1 w/v % HPMC in water. Since the mixture was discovered to synergistically suppress dust that was not shown by single polymers, this polymer mixture was referred to as “polymer blend”. Various polymer blend formulations were prepared by 0.1% HPMC with increasing L62 concentrations from 0.1% to 1% in water, and applied for the soil dust control. The synergistic dust suppression effect was still maintained whether L62 concentrations were increased up to 1% (FIG. 4). Therefore, it was concluded that the polymer blend by L62 and HPMC has advantages for the soil dust control because of their synergistic effect on dust suppression compared to the formulations prepared with the single polymers and for the utilization of common water spray systems, enabled by reduced viscosity by the polymer blend (FIG. 3).

The developed polymer formulations (exemplary embodiments of the invention) successfully suppress mine tailings dust (i.e. rock particles) or soil dust which were able to be immersed into water.

Suppression of Water Immiscible Coal Dust and Subway Dust

To understand the dust suppression capability of the compositions of the invention on other types of dust, coal dust and subway dust were used as model dusts that were not immersed in water.

Coal Dust Suppression

The coal dust is well-known for its hydrophobicity and thereby, special dust suppressants beyond just watering are necessary. Obtained coal was crushed by a pestle in a mortar, and particles smaller than 150 μm in a diameter were collected using USA standard 100 mesh sieve and used as coal dust samples.

A sink test was conducted to investigate what formulations can immerse coal dust into water. Formulations, including 0.1% L62, 0.1% HPMC or the polymer blend by both, were prepared. The coal sample of 0.5 g was poured into each glass vial after the vials were filled with 5 mL volume of each formulation (FIG. 5). It was observed that coal dust samples were not immersed into water or 0.1% HPMC formulation (picture is not shown). On the other hands, when 0.1% L62 was included in water, coal particles had immersed in the formulation, and further, when 0.1% HPMC was added into the L62 formulation, sizes of coal particle were distinctively going greater than the sizes of particles in only L62 formulation (FIG. 5). This suggests that L62 wet the hydrophobic coal particles, assist HPMC to mix well with coal particles, and promotes the agglomeration of coal particles with polymers, resulting in larger coal particle immersion in water. This also indirectly indicates that if the formulation is applied to coal dust sources, numbers of respirable small coal particles (PM2.5 and PM10) will be reduced by increasing their sizes and weights during the operation of coal mining process or coal power plant which will potentially mitigate public health concerns related to respirable coal-related diseases, such as black-lung disease or coal-workers' pneumoconiosis.

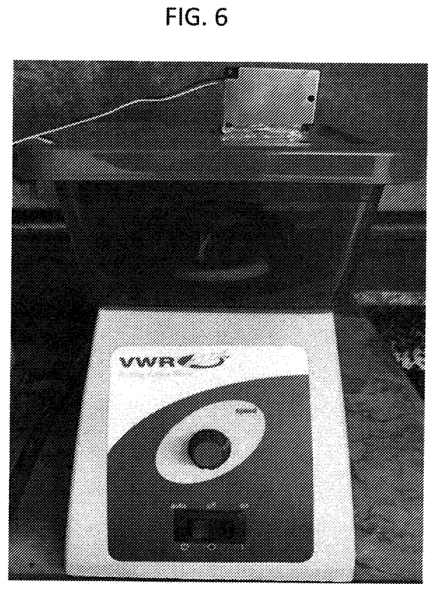

To test this conjecture, the L62 and the polymer blend formulations were applied, where coal particles were able to be immersed into those formulations (FIG. 5), to coal dust samples and dried for 3 days on the hotplate at 40° C. To mimic the situation where coal will be transported on the conveyor belt from the loading/unloading dock to the coal yard, the coal samples were vortexed with the motor speed of 1,500 rpm (FIG. 6). Three sets of each sample were prepared and PM2.5 and PM10 concentrations in a closed chamber were measured by the SDS-021 dust sensor over an hour. The highest values of PM10 and PM2.5 were collected over an hour measurement from three separate experiments to calculate average and standard deviation of the maximum coal dust concentration from samples treated by each formulation type.

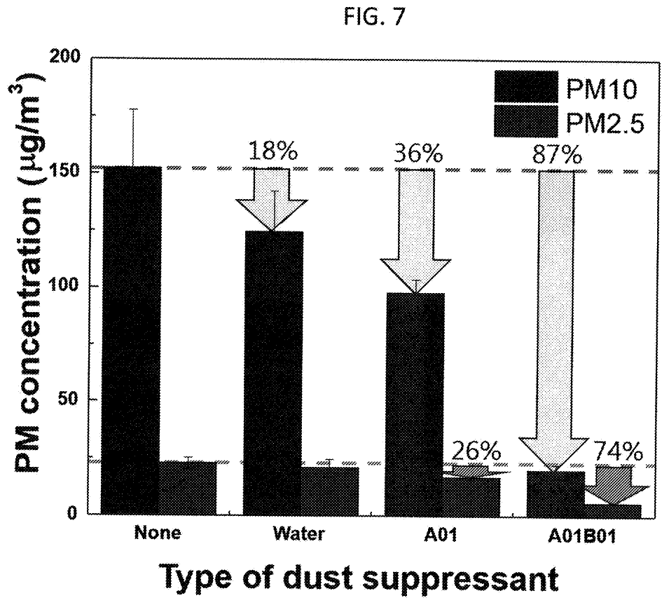

When PM10 and PM2.5 coal concentrations were measured on top of the sample stage over an hour (FIG. 6), compared to the non-treated sample, the water-treated sample reduced PM10 concentration about 18% but there was almost no PM2.5 reduction (FIG. 7). When 0.1% L62 formulation was applied, respirable PM10 and PM2.5 coal dust were reduced by 36% and 26%. Surprisingly, the polymer blend formulation decreased PM10 and PM2.5 by 87% and 74%. This synergistic effect by both polymers should be matched to the observation during the sink test (FIG. 5) where L62 wetted coal particles in water and then, coal particles were agglomerated by polymers, resulting in larger and heavier particle sizes which reduced PM2.5 and PM10 concentrations even after the water evaporation (drying condition: 40° C. for 3 days).

After transporting coals from the unloading/loading dock to the coal yard using the conveyer belt, the environment, such as wind, can affect coal dust amounts in air and create “fugitive coal dust”. To mimic the situation, tested samples on the vortex equipment (FIG. 6) were placed in the home-made air-blowing apparatus (FIG. 1) to apply the compressed air (20 psi) on the samples and measure PM10 and PM2.5 concentrations in the closed chamber.

When the air (wind speed: 50 km/h) applied to the sample surface, PM10 and PM2.5 concentrations of non-, water- and L62-treated samples reached to the sensor limitation of 2,000 μg/m³ and 1,000 μg/m³, respectively (FIG. 8). However, the sample treated by the polymer blend significantly reduced the coal dust with PM10 of 50 μg/m³ and PM2.5 of 33.2 μg/m³. Compared to other samples that are non-treated or treated by water or L62, the polymer blend reduced more than 97% of dust concentrations. It was not possible to precisely compare the reduction percentage between the formulations because the dust concentrations were out of the dust sensor range. Based on the vortexing experiment (FIG. 7) and air-blowing experiment (FIG. 8), it is clear that the polymer blend, prepared by L62 and HPMC, synergistically mitigate coal dust by enhancing coal particle wettability and agglomeration.

Subway Dust Suppression

Furthermore, application the polymer blend formulation for the mitigation of dust from the subway was investigated. During the subway operation, the dust that potentially threatens passengers can be generated from three main sources: (1) pantograph and utilities, (2) brake pad, wheel and railway and (3) re-dispersion of settled dust. To provide good quality of air to the passengers under the ground, it requires proper air flow, air filtering system, and dust cleaning methods. Currently, there are air filtering system in the subway and the tunnel is cleaned by watering.

Subway dust was obtained and conducted the sink test to investigate the dust property (i.e. hydrophilic or hydrophobic) and the capability of developed formulations to immerse the dust into water if the dust is hydrophobic, similarly to the coal dust. Formulations were prepared with 0.1 w/v % L62, 0.1 w/v % HPMC or the polymer blend by both in water. The subway dust particles smaller than 150 μm in a diameter were collected by using USA standard 100 mesh sieve and used as dust samples. Similar to the coal dust sink test (FIG. 5), the sample of 0.5 g was poured into each glass vial (FIG. 10). Similar to the coal sample, the subway dust sample was not immersed into water or 0.1% HPMC formulation, and thereby, it was discovered that the subway dust is hydrophobic, meaning that conventional watering method for subway dust mitigation would be ineffective since the dust cannot be mixed well with water. However, when 0.1% L62 formulation was applied, the dust particles had immersed into the formulation, and further, when 0.1% HPMC was added into the L62 formulation, sizes of the dust particle were going greater than the sizes of particles in only L62 formulation, and the more particles were dropped into water (FIG. 10). Therefore, based on the sink test experiments with the subway dust and coal dust, it is suggested that the polymer blend formulation is highly efficient to control hydrophobic dust because HPMC promotes the agglomeration of hydrophobic dust particles while L62 wet the hydrophobic dust into the formulation.

To confirm whether the conclusion from coal dust result is applicable to the subway dust and generalize the capability of the polymer blend formulation on the mitigation of various types of hydrophobic dust, the air-blowing test was performed with subway dust samples treated with water, L62, HPMC and the polymer blend. Trays, containing 30 g of subway dust samples, were filled with 40 mL of each formulation to fully cover whole dust surface. After drying samples for a week at room temperature, the tray was located at the home-made air-blowing testing apparatus (FIG. 1). The compressed air (20 psi) applied to the sample surface (50 km/h) and PM2.5 and PM10 concentrations in the chamber were measured by the sensor.

Compared to the dried sample after treated by only water, PM2.5 and PM10 concentrations from the sample treated by 0.05% HPMC formulation were reduced by 64% and 68%, respectively (FIG. 11). It is interesting to note that PM2.5 and PM10 were reduced by 49% and 50% when the sample was treated by 0.1% HPMC formulation, meaning that increasing HPMC concentration in the formulation negatively impacted on the dust control, suggesting appropriate polymer concentrations in the formulation are necessary for the optimal subway dust suppression.

The air-blowing test was also performed on samples treated with L62 and polymer blend formulation with various polymer concentrations (FIG. 11). When compressed air applied to the samples, no matter what polymer concentrations were used (<=5% L62 and <=0.1% HPMC+<=5% L62), PM2.5 and PM10 concentrations of subway dust in air did not exceed 10 μg/m³. Therefore, it was discovered that both L62 and the polymer blend formulations are effective to suppress subway dust. Note that the polymer blend is more effective to mix hydrophobic subway dust in water than amphiphilic polymer L62 alone (FIG. 10).

Further, the sustainability of dust suppression effectiveness was investigated. Tested samples (FIG. 11) were stored at room temperature for two months and the compressed air (20 psi) was applied on the sample surface to measure the PM2.5 and PM10 concentrations in the closed chamber. Compared to the sample prepared in week 1, in week 8, the sample treated by only water increased the PM10 and PM2.5 dust concentrations by 48% and 59% (FIG. 11 and FIG. 12). Compared to the sample treated by water in week 8, the dust concentrations from the sample treated by 0.1% HPMC formulation were significantly increased by more than 80% and 90% in PM2.5 and PM10 but when the samples were treated by 0.05% HPMC formulation, PM10 and PM2.5 were reduced by 28% and 34%. This data indicates that less HPMC concentration in the formulation is more effective if only HPMC is utilized as subway dust suppressant and further, compared to dust treatment by only watering, >0.1% HPMC formulation is worse to mitigate subway dust for long-term. On the other hands, the dust control was still effective when the samples were treated by the formulations either L62 or the polymer blend (FIG. 12) when compared to the dust concentrations from week 1 (FIG. 11). The PM10 and PM2.5 concentrations were around or below 15 μg/m³, except the sample treated by 1% L62 where the sample surface was disrupted by 50 km/h wind speed and the emitted dust reached to the sensor limitation. This could be occurred due to the weak agglomeration between dust particles and the polymer, compared to the polymer blends where 1% L62 were mixed with 0.05% HPMC or 0.1% HPMC (FIG. 12). To test this conjecture, the pressure of the compressed air was increased from 20 psi to 30 psi (wind speed on the sample surface: 80 km/h) and applied onto the samples to investigate the surface stability of samples, and measure PM2.5 and PM10 concentrations.

When higher compressed air (30 psi; 80 km/h of wind speed on the sample surface) applied onto the surface of samples, the polymer blend formulations generally show better surface stability and dust suppression effectiveness than L62 formulation alone. As expected, PMs from samples treated by only water or HPMC increased when the air-blowing speed was increased. Similar to the sample treated by 1% L62 where 50 km/h wind speed applied (FIG. 12), the surface of the sample treated by 3% L62 formulation was disrupted with the compressed air with 80 km/h air-blowing speed and reached to the sensor limitation (data is not shown). Furthermore, PM10 and PM2.5 concentrations of the sample treated by 5% L62 were significantly increased from 14±3 μg/m³ to 111±41 μg/m³ and 3±1 μg/m³ to 35±11 μg/m³, respectively when air-blowing speed is increased from 50 km/h to 80 km/h. Based on L62 formulation results, it can be concluded that samples treated by less L62 concentrations lead to less stable sample surface (FIG. 12 and FIG. 13). On the other hands, PM10 and PM2.5 from samples treated with the polymer blends were below or around 30 μg/m³ and 10 μg/m³, respectively (FIG. 13), except the sample treated by 3% L62 and 0.1% HPMC where the surface was disrupted and reached to the sensor limitation (data is not shown). It is difficult to understand the reason of the sample disruption when treated by the polymer blend (3% L62 and 0.1% HPMC) but it is clear that this could be not due to that specific polymer blend concentration weakened the surface since other polymer blends were stable in week 8 with different wind speeds (FIG. 13). Therefore, it was discovered that to control subway dust, the polymer blends can be prepared by 1-5 w/v % of L62 and >=0.05% of HPMC in water and this will synergistically immerse hydrophobic subway dust into water and stabilize the dust for long-term (>2 months).

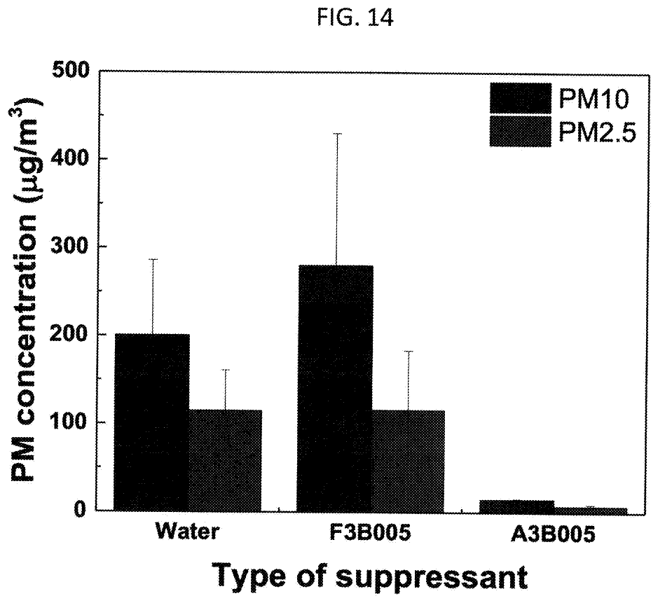

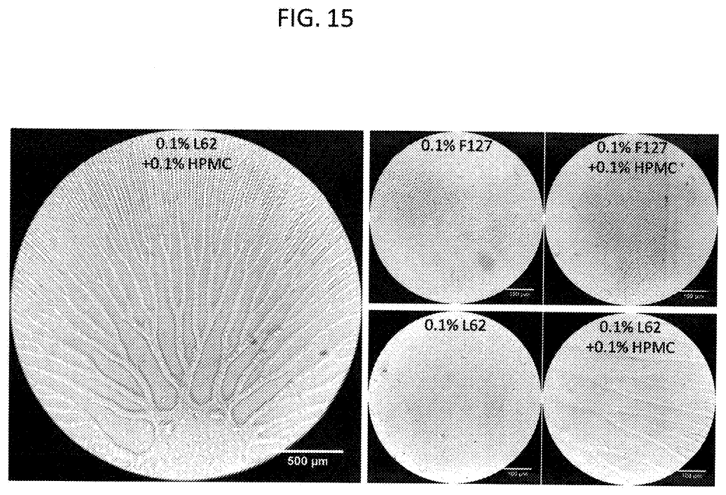

The synergistic effect of the polymer blend formulation was revealed when liquid amphiphilic polymer (e.g. L62) is mixed with HPMC, while the formulation replacing liquid amphiphilic polymer to solid (e.g. F127) were not as effective on subway dust suppression. Compared to the PM concentrations of the sample treated by water (FIG. 14), the blend formulation (3% L62 and 0.05% HPMC) decreased PM10 and PM2.5 concentrations by about 90%, while the formulation (3% F127 and 0.05% HPMC) increased PM10 concentration by about 40% and the PM2.5 concentration was statistically equal to the value of the sample treated by water. It indicated that the liquid state is required for highly effective dust suppression. Microscope analysis also revealed that, when water evaporation is completed, the blend formulations comprising L62 and HPMC formed wetted branch-like structure, whereas the polymer blends of F127 and HPMC constructed rigid film-like structure (FIG. 15). It is clear that due to the wetted branch-like structure the L62 and HPMC blend formulation can effectively reduce PM concentrations by about 90%, preventing dust particles from escaping, but the blend formulation of F127 and HPMC shows 40% higher PM10 concentration than the sample treated by water (FIG. 14). This could be caused by the contribution of the solid polymer particles, broken away by wind speed 50 km/h, in addition to the subway dust. It demonstrates that the polymer blend formulations comprising liquid amphiphilic polymer and HPMC are highly effective dust suppressant.

Reduced Oxygen Adsorption to Coal Surface when Polymer Blends Applied to Coal Stockpiles.

To investigate the effect of the compositions of the invention on the coal surface to coal-oxygen adsorption or self-heating, water and aqueous solutions of liquid polymer and polymer blend was applied to coals and dried them for a week. Then, the thermogravimetric analysis (TGA) were performed on dried coal samples (FIG. 9). When temperature increased, due to the water evaporation, there were weight loss of the sample up to ˜150° C. At 150-250° C., due to the oxidation process or oxygen adsorption on coal surfaces, the measured weight was increased. From this data, self-heating rate (ΔW; %) was calculated. When liquid polymer was applied, ΔW is more reduced than the sample applied with only water but there is no significant statistical enhancement (p-value>0.05). However, when the polymer blend applied, ΔW decreased ˜68% compared to the non-treated sample or the sample applied with only water. This indicates that the polymer blend can coat the coal samples well and coated the polymer blend layer on coal surfaces can effectively reduce oxygen adsorption or self-heating process.

Self-heating rate (ΔW; %) were calculated by subtracting the maximum and the minimum between 100 and 270° C. where water evaporation and oxygen adsorption to coal particles occur respectively. A and B denote L62 and HPMC, respectively. 1 and 005 denote 1 and 0.05 w/v % of polymers in water, respectively.

It is to be understood that both the foregoing general description of the invention and the following detailed description are exemplary, and thus do not restrict the scope of the invention.

A number of publications are cited above in order to more fully describe and disclose the invention and the state of the art to which the invention pertains. Full citations for these references are provided below. Each of these publications is incorporated herein by reference in its entirety into the present disclosure, to the same extent as if each individual reference was specifically and individually indicated to be incorporated by reference.

### REFERENCES

[1] K. Staif, A. Cohen, and J. Samet, Air Pollution and Cancer, IARC SCIENTIFIC PUBLICATION NO. 161, WHO, (2013), 1-169.
[2] F. Kissell, Handbook for Dust Control in Mining, IC9465, NIOSH, (2003), 1-131.
[3] A. B. Cecala, A. D. O'Brien, J. Schall, J. F. Colinet, W. R. Fox, R. J. Fanta, J. Joy, Wm. R. Reed, P. W. Reeser, J. R. Rounds and M. J. Schultz, Dust Control Handbook for Industrial Minerals Mining and Processing, RI9689, NIOSH, (2012), 1-284.
[4] P. Bolander, Chemical Additives for Dust Control: What We Have Used and What We have Learned, Transportation Research Record 1589, 1, (2007). 42-49.
[5] W. Zeller, Laboratory Tests for Selecting Wetting Agents for Coal Dust Control, Bureau of Mines, RI8815, (1983), 1-21.

1. A dust suppression composition comprising a cellulose ether and a liquid amphiphilic polymer.

2. The dust suppression composition according to claim 1, wherein said composition further comprises a diluting agent.

3. The dust suppression composition according to claim 1, wherein:
(a) said cellulose ether is present in an amount ranging from about 0.01% to about 0.1%;
(b) said liquid amphiphilic polymer is present in an amount ranging from about 0.1% to about 5%;
(c) said water is present in an amount ranging from about 94.9% to about 99.89%; and
(d) wherein said amounts are based on the total weight of the composition.

4. The dust suppression composition according to claim 1, wherein said cellulose ether is hydroxypropyl methylcellulose, hypromellose, or HPMC.

5. The dust suppression composition according to claim 4, wherein said HPMC has a viscosity of about 10,000 to about 300,000 cps.

6. The dust suppression composition according to claim 1, wherein said liquid amphiphilic polymer is poloxamer 182 (also known as Pluronic L62) or liquid amphiphilic block copolymers composed of polyethylene oxide (PEO) or polyethylene glycol (PEG) and polypropylene oxide (PPO) or polypropylene glycol (PPG).

7. A method of suppressing dust, said method comprising contacting a composition according to claim 1 with dust, wherein the amount of said dust is reduced such that the amount of said dust is less than when none of said composition is applied.

8. A method of making a concentrated dust suppression composition, said method comprising combining cellulose ether, a liquid amphiphilic polymer, and a diluting agent.

9. The method of claim 8, wherein said method comprises
(a) Adding both a cellulose ether and a liquid amphiphilic polymer in the weight ratio of about 1:1 to about 1:700;
(b) keep the mixture until the cellulose ether is immersed with liquid amphiphilic polymer;
(c) Stir the mixture;
(d) Add same amount of diluting agent with the amount of liquid amphiphilic polymer;
(e) Stir the mixture;
(f) Dry the mixture
(g) obtain said a concentrated dust suppression composition, wherein said concentrated dust suppression composition is a solid concentrate or a liquid concentrate.

10. The composition of claim 1, wherein said composition is a solid concentrate comprising a cellulose ether and a liquid amphiphilic polymer, and optionally a diluting agent, wherein said cellulose ether and said liquid amphiphilic is present in a ratio of 1:less than 5 and wherein the ratio of said diluting agent to said concentrate ranges from 0:1 to 1:3.

11. The composition of claim 1, wherein said composition is a liquid concentrate comprising a cellulose ether, a liquid amphiphilic polymer, and optionally a diluting agent, wherein the ratio of a cellulose ether to a liquid amphiphilic polymer is 1:greater than or equal to 5 and 1:less than or equal to 700 and wherein the ratio of diluting agent to said concentrate ranges from 0:1 to 1:1.

12. The composition of claim 10, where said concentrate comprises 50.0% to 85.1% of liquid amphiphilic polymer and 50.0% to 14.9% of cellulose ether.

13-29. (canceled)

30. The composition of claim 10, where said composition comprises 46.2-50% of liquid amphiphilic polymer, 7.7-0.1% of cellulose ether, and 46.2-50% of water.

31-39. (canceled)

40. The composition of claim 10, where said cellulose ether, said liquid amphiphilic polymer, and said water are present in a ratio of at least 1:1:0, respectively.

41-66. (canceled)

67. The composition according to claim 2, wherein said diluting agent is water.

68. The composition of claim 11, where said cellulose ether, said liquid amphiphilic polymer, and said water are present in a ratio of at least 1:1:0, respectively.
